(19) United States
(12) Patent Application Publication
(10) Pub. No.: US 2009/0301316 A1
(43) Pub. Date: Dec. 10, 2009

(54) KIT FOR HOME PREPARATION OF SUSHI

(76) Inventors: Yehuda Yavets-Chen, Caesaria (IL); Chanoch Farber, Caesaria (IL)

Correspondence Address: Pearl Cohen Zedek Latzer, LLP, 1500 Broadway, 12th Floor, New York, NY, 10036, US

(21) Appl. No.: 10/568,421

(22) PCT Filed: Aug. 17, 2004
(86) PCT No.: PCT/IL2004/000752

§ 371 Date: Apr. 8, 2009

(30) Foreign Application Priority Data
Aug. 19, 2003 (IL) 157483

(51) Int. Cl. A21C 9/00; A47J 43/20

(52) U.S. Cl. 99/450.1; 99/450.6; 99/450.7

(57) ABSTRACT

The sushi maker machine (10) comprises a base-plate (12) supporting a roll making sheet and a roll-up sheet removably held on the base-plate in a substantially flat condition held by clamps (14) or similar arrangement allowing for the deposit of a layer of seaweed (Nori) and other ingredients over the sheet. When released from the clamps (14) the sheet taking up a cylindrical configuration or rolled up mechanically. A cooked rice container (22) mounted on vertical or horizontal rails (24) or a like supported such as parallel bars, the container having a first position at a side or top of the roll-up sheet wherein the rice may be arranged and a second position, above the roll-up sheet wherein a layer of rice may be deposited onto the seaweed layer.

### FIELD AND BACKGROUND OF THE INVENTION

The present invention relates to home and commercial food preparation. More particularly, the invention provides a small machine for home and commercial use for the preparation of sushi.

Sushi rolls were developed in Japan and have become popular also in other countries. While there are many variations, a typical sushi roll comprises akin outer layer of dried seaweed (Nori), a thick intermediate layer of cooked rice typically seasoned with vinegar, and an inner filling of meat or fish (usually raw) and vegetables. Spices (for example horseradish paste, or picante sauce) can be added. The roll is cut into slices about 20 mm wide. Professional machinery is available for sushi preparation, for example “ROBOT” machinery marketed by the TOYO CORPORATION, is suitable for use in outlets where demand is high in restaurants, hotels and of course in sushi bars. However in high-class outlets a skilled person called a Sushi Chef is in charge of sushi preparation, and he often carries out most of the work himself while the customer looks on.

Resulting from the popularity of sushi-type foods served at hotels and other public outlets, a significant segment of the population has become interested in preparing such food at home, while at the same time experimenting with the use of various ingredients. Primitive results can be achieved without the use of special equipment Better results are available by the use of prior-art dedicated-purpose equipment, which includes items such as a rectangular section mold for the cooked rice, provided with a presser member and knife guide slots for final slicing.

A further example of primitive equipment for home preparation of sushi is seen In U.S. Pat. No. 6,465,038 B2 to Aoki, who discloses a pair of trays, one tray having projections to help separate the sushi from the tray, the projections engaging holes in a second tray.

Thus there remains a gap in the supply of sushi making devices between large automatic machinery, which is totally unsuitable for home use or small restaurants and the primitive devices which do not provide a complete solution, and do not provide help—for example, in the rolling process. In particular many prior-art devices and methods require manual contact with the cooked rice, which is sticky and requires handling with wet fingers.

### OBJECTS OF THE INVENTION

It is therefore one of the objects of the present invention to obviate the disadvantages of prior art sushi preparation kits or devices and to provide an advanced small machine which includes means for carrying out the rolling operation for domestic and small outlets use.

It is a further object of the present invention to provide a moderate-cost sushi preparation machine which obviates the need for hand contact with food items.

It is yet a further object of the present invention to provide a sushi preparation machine adopted to operate manually or electrically by means of a number of electric motors.

### SUMMARY OF THE INVENTION

The present invention achieves the above objects by providing a sushi maker machine for home or small outlets use, comprising
a base-plate supporting a roll making sheet;
a roll-up sheet removably held on said base-plate in a substantially flat condition held by clamps or similar arrangement allowing for the deposit of a layer of seaweed (Nori) and other ingredients over said sheet, and when released from said clamps said sheet taking up a cylindrical configuration or rolled up mechanically; and
a cooked rice container mounted on vertical or horizontal rails or a like supported such as parallel bars, said container having a first position at a side or top of said roll-up sheet wherein said rice may be arranged and a second position, above said roll-up sheet wherein a layer of rice may be deposited onto said seaweed layer.

In a preferred embodiment of the present invention there is provided a sushi maker machine further including a mechanism attached to said base-plate, said mechanism allowing for controlled gradual release and roll of said roll-up sheet from its flat configuration to its cylindrical form.

In a most preferred embodiment of the present invention there is provided a sushi maker machine wherein said cooked rice container has a substantially open bottom face, the rice being retained therein by an array of thin elements rigidly supported by said container.

Furthermore, the sushi maker machine wherein the cooked rice container may include a cutting device for slicing off a lowest layer of cooked rice for deposit onto said seaweed layer. Being suspended on rails above the base board greatly eases the task of cutting off the lower layer of cooked rice, whether cutting is being done with the device integral to the rice container.

Using the sushi maker machine enables to have full control over the width of the rice layer for different sized of sushi rolls.

Yet further embodiments of the invention will be described hereinafter.

It will thus be realized that the advanced device of the present invention serves to ease the preparation task and to enhance the quality of the product. By use of the simple mechanisms to be described, any one can, with a little practice, prepare sushi rolls indistinguishable from those made by a professional.

Many different sushi recipes have been published, for example on the internet sites SurfTilYouDrop.com and digsmagazine.com. The machine of the present invention is suitable for preparing practically any type of sushi roll, thus becoming a useful appliance which will be in much use in the kitchen.

While the device of the present invention will be used primarily in private homes, the machine will also be useful in public outlets where a moderate quantity of sushi food is sold and for which there is no economic justification or room for automatic machinery which can produce about 3000 portions per hour.

The simple manual version would be most suitable for domestic use while an electric version would be more suitable for small outlets.

### SHORT DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1a is a perspective view of a basic embodiment of the sushi making machine according to the invention, the metal plate being shown in its flat condition;

FIG. 1b is a perspective view, the metal plate being shown in its cylindrical state;

FIG. 2 is a perspective view of a bamboo mat which can be used to receive the seaweed;

FIG. 3 is a perspective view of an embodiment including a mechanism for opening/closing the roll-up sheet;

FIG. 4 is an elevational view of a more advanced mechanism for opening/closing the roll-up sheet;

FIG. 5 is a perspective view of a cooked-rice container;

FIG. 6 is a perspective view of an embodiment provided with a cutting device for the rice layer;

FIG. 7 is a perspective view of an embodiment provided with a cutting device for the rice layer;

FIG. 8 is a perspective fragmented view a further embodiment provided with a cutting device for the rice layer;

FIG. 9 is a detail view of a preferred embodiment of the device seen in FIG. 10;

FIG. 10 is a front elevational view of an embodiment provided with a cut-off mechanism; and.

FIG. 11 is a front elevational view of the same embodiment seen with the cutting device being operated.

### DETAILED DESCRIPTION OF THE DRAWINGS

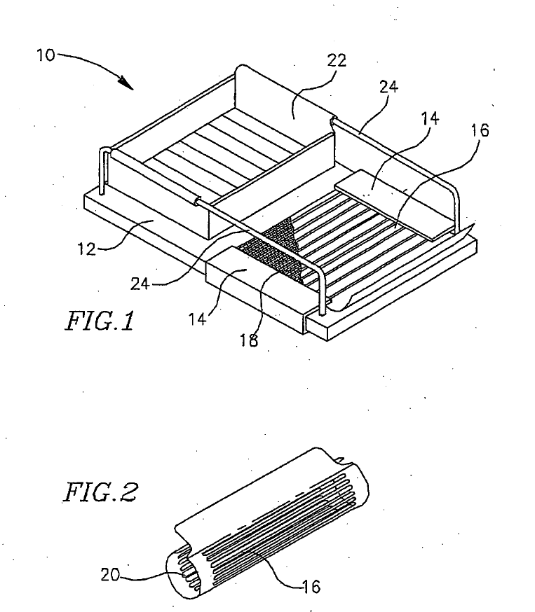

There is seen in FIG. 1a a simple basic sushi maker device 10, primarily intended for home use.

A base-plate or base frame 12, suitably made of wood or metal, supports a pair of opposed angles 14 which act as clamps for a roll-up sheet 16.

The roll-up sheet 16 being inserted under the angle clamps 14 is removably held on top of the base-plate 12 in a substantially flat condition. The angle clamps 14 engage the sheet 16 adjacent to its corners and allow the user to deposit a bamboo mat and a layer of seaweed 18 and other ingredients over the sheet 16.

When released from the clamps 14 the sheet 16 takes up a cylindrical configuration, as seen in FIG. 1b. This view shows a multiplicity of slots 20 running parallel to the axis of curl. At the four corners of sheet 16 preferably there are provided four end portion 17 to be inserted under angle clamps 14. Instead of a metal sheet a rubber on the like material could be used. The metal roll-up sheet could be replaced by a rubber sheet or the like material.

A cooked-rice container 22 is mounted on rails 24 supported by the base-plate 12. The container 22 can be slid along the rails 24 by hand. The container 22 has a first position, seen in the figure, at a side of the roll-up sheet 16. At this position cooked rice 106, seen in FIG. 7, may be arranged therein.

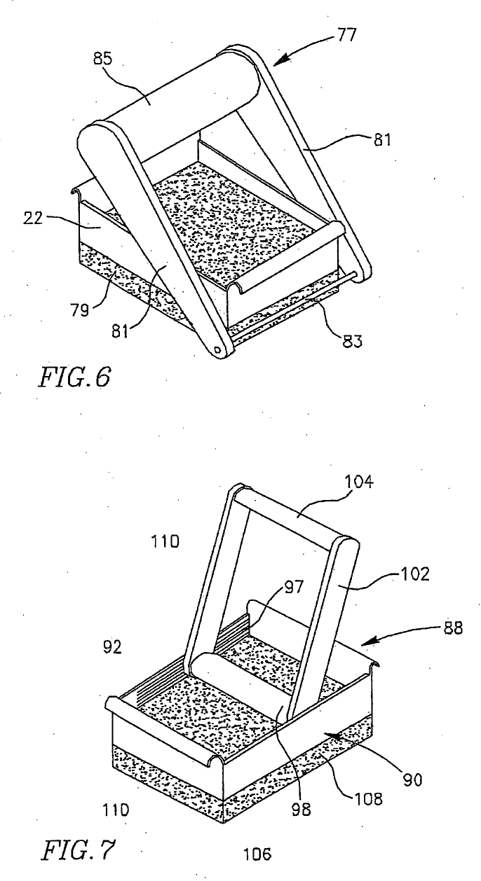

The rails 24 allow the user to push the container 22 to a second position, above the roll-up sheet 16. In this position a layer of rice may be extruded, and cut as seen in FIG. 6, and deposited on top of the layer of seaweed 18. It is within the scope of the invention to fix the rice container and move base plate 12 relative to the container, the base plate being mounted on rails to enable such movement. Base plate 12 may be equipped with a lead screw to obtain a smooth back and forth movement. Such lead screw could also be connected to an electric motor.

It is within the scope of the invention to mount the container 22 on vertical rails or by means of a parallelogram Both options also render two positions of the container. Further kitchen tools could be provided, but most users already have these available, so their omission reduces the cost of the sushi machine.

With reference to the rest of the figures, similar reference numerals have been used to identify similar parts.

Referring now to FIG. 2, there is seen a bamboo mat 30 which is about the same size as the roll-up sheet 16. The bamboo mat 30 can be curled into a circular shape about 4-5 cm diameter.

In use, the mat 30 is placed on top of the roll-up sheet 16, and thus the seaweed layer 18 is placed on top of the mat 30 instead of directly on the roll-up sheet 16 seen in FIG. 1. The mat 30 is used for rolling up the various food layers and is removed for reuse before final slicing of the sushi roll. It is clear that it is possible to place the seaweed directly on sheet 16, irrespective whether of metal or other material.

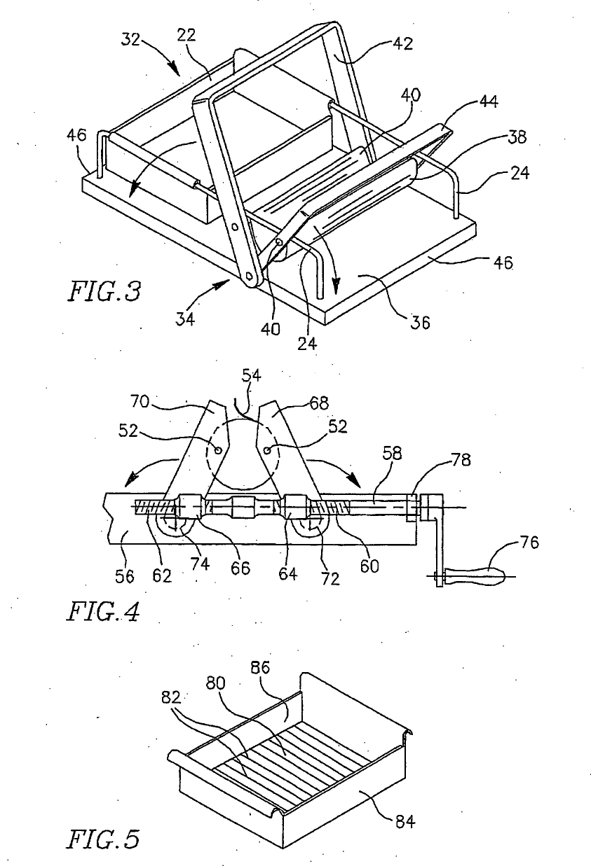

FIG. 3 illustrates a sushi maker 32 her including a mechanism 34 attached to the base-plate 36 for opening/closing the roll-up sheet 38. Clamp rods 40 are held in a transverse position by each of two U-shaped members 42, 44 pivoted to the base-plate 36. Each clamp rod 40 contacts the roll-up sheet 38. The U-shaped members 42, 44 may be manually swung downwards and to be retained by edges 46, 48 the base-plate 36, causing the clamp rods 40 to flatten and retain the roll-up sheet 38 in a substantially flat condition and resting on top of the base-plate 36.

The mechanism 34 also serves to allow controlled gradual release of the roll-up sheet 38 from its fiat configuration to its cylindrical form. The roll-up sheet 38 is seen in the diagram in an intermediate position.

Seen in FIG. 4 is a detail of a sushi maker 50 showing clamp members 52 which release the roll-up sheet 54 to its cylindrical form, and clamp and temporarily retain the sheet 54 in its flat form.

A mechanism attached to the base-plate 56 has a lead screw 58 wherein a first section has a left-hand screw thread 60 and a second section has a right-hand screw thread 62. Appropriate swivel nut elements 64, 66 allow the lead screw 58 to drive a first pair of levers 68,70 around base pivots 72,74 in opposite directions of rotation. A similar second pair of levers (hidden by the directly opposite first pair of levers 68, 70) on the opposite side of the base-plate 56 are rigidly connected to and driven by the first pair of levers 68, 70. Each lever carries a rod clamp member 52 positioned to open/release the roll-up sheet 54.

The screw 58 is revolvably supported from the base plate 56 by means of a bearing 78, and is driven by means of a handle 76. Instead of handle 76 lead screw 58 may be connected to a small electric motor in order to perform the revolving of the screw.

Referring now to FIG. 5, there is depicted an important component of the sushi maker briefly referred to with reference to FIG. 1. The cooked-rice container 22 serves to enable the user to prepare the cooked rice, compress it, extrude it and part off the rice layer slice above the roll-up sheet or above the bamboo mat 30 referred to in FIG. 2, forming the main body of the sushi roll.

The container 22 has a substantially open bottom face 80, allowing rice to be extruded therethrough. Before extrusion the rice is retained in the container 22 by an array of thin elements 82. The thin elements 82 seen in the figure are made of stainless steel wire suspended by the container sides 84, 86. Stainless steel strips oriented in a vertical plane can be used in place of the wire. The wires could be arranged in “X” or “Y” axis orientation.

In operation the user applies an extrusion force on top of the rice which then overcomes the resistance of the thin elements 82, part of the rice passes through the open face 80 thereafter allowing cut-off of the desired thickness rice layer, as will be seen in the following figure.

Turning now to FIG. 6, there is shown part of an embodiment wherein the sushi maker includes a manual cutting device 77 for slicing-off the layer of cooked-rice 79 previously extruded and now projecting from under the container 22.

The cutting device 77 of the present embodiment comprises a pair of arms 81 spaced apart to straddle the container 22. A taut wire 83 is suspended between the arms 81, arranged to cut off the lowest layer of cooked rice 79 for deposit onto the seaweed layer 18 seen in FIG. 1a. The cutting device 77 is manually pulled by use of a handle 85.

FIG. 7 illustrates a part of a sushi maker 88 provided with a rice compression device.

The container 90 is provided with a number of steps 92 or ribs, one above the other, on the inner face of both longitudinal walls 94, 96. A short gap 97 at the end of each step 92 (except the lowest) enables engagement of the end projections of the roller shaft (not seen). The roller 98 is preferably Teflon coated. The roller shaft is suspended between a pair of spaced-apart arms 100, 102, the arms being interconnected at their upper ends by a handle 104.

In operation the user manipulates the handle 104 to roll over and evenly compress the cooked rice 106 held in the container 90. Extrusion of the rice 106 through the container bottom 108 is achieved by moving the roller 98 to above a gap 97, pressing the handle 104 downwards so that the shaft ends engage a lower step 92, and again pulling the handle 104 to roll over the top surface of the rice 106. Continuation of this operation leads to the desired extrusion of a rice layer 110 of the desired thickness, after passing between the plurality of thin elements 82 which are visible in FIG. 5. Instead of rolls 98 a flat substantially rectangular plate could be placed on top of the rice, applying pressure on the plate will result a released of a portion of rice.

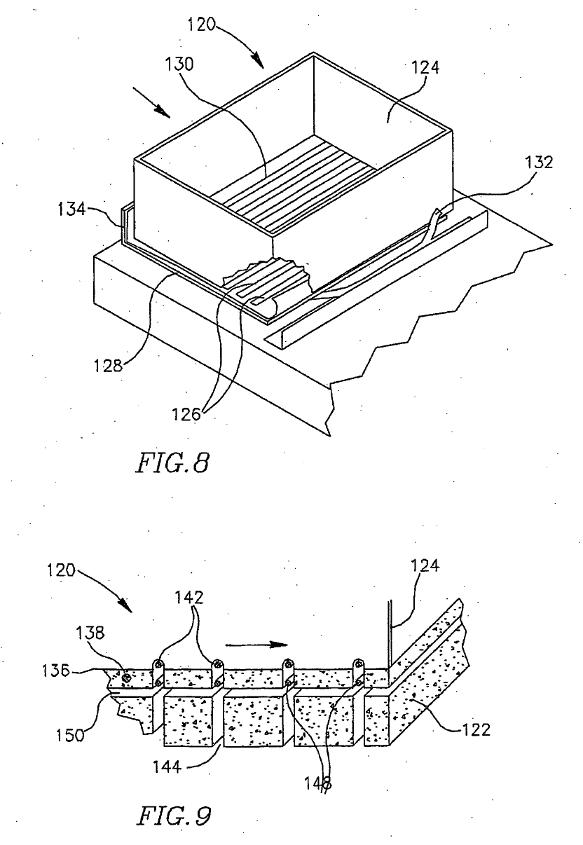

Turning now to FIG. 8, there is seen an additional embodiment of the sushi maker 120 fitted with a cutting device for slicing off a lowest layer of compressed cooked rice 122, seen in FIG. 9.

Directly underneath the cooked rice container 124 there are seen multiple spaced-apart cutter elements 126 retained in a rigid outer frame 128. A similar set of spaced apart elements 130 are seen at the open bottom of the container 124; the elements 130 retain the cooked rice before extrusion pressure is applied thereto. After extrusion the elements stabilize the rice structure during the cutting off procedure. Cutting off is effected by relative longitudinal movement between the container 124 and the cutter rigid outer frame 128. Due- to, the multiple cutter elements 126, it is only necessary to generate movement over a distance substantially equal to the distance between the cutter elements 126.

In the shown embodiment it is the container 124 which is pushed towards the near right, as seen in the figure, to effect cutting. The cutter rigid outer frame 128 is held stationary. It is of course feasible to reverse this arrangement and to drive or push the cutter frame while the container is clamped in place. Either way, the movement is performed either by hand or by an electric motor.

After slicing off a lowest layer of compressed cooked rice 122 a spring 132 returns the container 124 to its original position against a stop 134. The distance between elements 126 could be reduced by positioning of elements 130 of frame 128 not underneath 126 but inbetween.

FIG. 9 shows a detail of a preferred arrangement of the sushi maker 120 described with regard to FIG. 8. The cooked rice container 124 is again shown at its position before beginning the cutting off movement. The container 124 has a substantially open bottom face 136 allowing cooked compressed rice 138 to be extruded therethrough Before extrusion the rice is retained in the container 124 by an array of thin elements 142. During extrusion “grooves” 144 are formed in the extruded cooked rice as the layer 122 is pushed downwards. As extrusion continues, the “grooves” 144 already formed in the cooked rice layer 146 allow passage for the cutter elements 148 positioned directly below and in line with the array of thin elements 142 rigidly supported at the bottom of the container 124. This arrangement greatly reduces the need for a high extrusion force and furthermore helps to retain the cooked rice layer 122 in an orderly manner.

Preferably, the cutter elements 148 comprise this stainless steel wires. These can be retained in tension by means of the rigid frame 150.

The figure illustrates the arrangement directly before cutting off of the cooked rice layer 122.

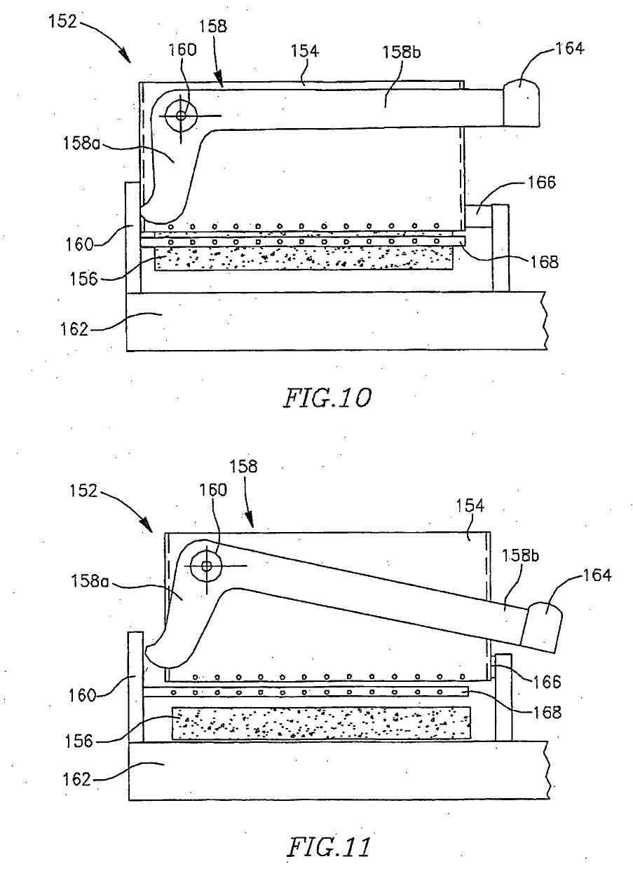

FIGS. 10 & 11 show part of a sushi maker 152 further provided with a mechanism for driving the cooked rice container 154 to effect cutting off of the extruded layer 156 of cooked, compressed rice. The mechanism seen comprises a pair of crank levers 158 (the unseen rear crank lever being identical to the visible front side lever). The crank levers 158 provide a mechanical advantage of about 2. Both crank levers 158 are pivoted at 160 to the upper part of the cooked rice container 154. The short aim 158a of each crank lever 158 is arranged to contact a fixed wall 160 extending from the machine frame 162.

The long arms 158b of the crank levers are interconnected by a handle 164 extending across the width of the container 154.

The mechanism is arranged to be operated by hand. At the conclusion of extrusion of a rice layer, the user applies hand pressure to the handle 164 in a substantially downward direction, as is seen in FIG. 11. The container 154 is now seen after having been forced rightwards, against the return spring 166, causing the stationary rutting device 168 to cut off the extruded rice layer.156.

The advantage of actuation by means of downward pressure will be readily appreciated. The downward direction is the easiest direction for users to apply hand pressure. Furthermore, it is the only direction which does not require a counter-force to prevent unwanted movement of the device resting on a horizontal surface.

Alternatively cutting device 168 could be moved left and right relative to a stationary container 154. Such movement could be achieved either manually by a similar arrangement or by a small electric motor.

As became apparent from the above description the sushi maker performs five different operations all could be manually performed or by means of an electric motor. It is within the scope of the invention to operate the machine also pneumatically, hydraulically or any other suitable means.

We claim:

1. A sushi maker for home or commercial use, comprising
a base-plate supporting a roll making sheet;
a roll-up sheet removably held on said base-plate in a substantially flat condition held by clamps or similar arrangement allowing for the deposit of a layer of seaweed over said sheet, and when released from said clamps said sheet talking up a cylindrical configuration or rolled up mechanically; and
a cooked-rice container mounted on horizontal or vertical rails adopted to release a portion of rice over said base plate.

2. The sushi maker as claimed in claim 1 wherein said container is mounted by means of a parallelogram.

3. The sushi maker as claimed in claim 1, further provided with a bamboo mat configured to rest on said roll-up sheet and onto which said layer of seaweed may be deposited.

4. The sushi maker as claimed in claim 1, further including a mechanism attached to said base-plate and engaging said clamp members, said mechanism allowing for controlled gradual release of said roll-up sheet from its flat configuration to its cylindrical form.

5. The sushi maker as claimed in claim 1 wherein said roll-up sheet is provided with extended portions at its four corners.

6. The sushi maker as claimed in claim 3, wherein said mechanism is in the form of a left-hand right-hand screw rotatable by the user by means of a handle, said screw engaging nuts attached to said clamps.

7. The sushi maker as claimed in claim 1, wherein said cooked rice container has a substantially open bottom face, the rice being retained therein by an array of thin elements rigidly supported by said container.

8. The sushi maker as claimed in claim 1, wherein said cooked rice container includes a cutting device for slicing off a lowest layer of cooked rice for deposit onto said seaweed layer.

9. The sushi maker as claimed in claim 1, wherein said container is further provided with a compression device for compressing cooked rice held in said container, and for discharge of the lowest layer through gaps between said plurality of thin elements.

10. The sushi maker as claimed in claim 6, wherein said cutting device for slicing off a lowest layer of cooked rice comprises multiple spaced-apart cutter elements retained in a rigid outer frame, cutting off being effected by relative longitudinal movement between said cooked rice container and said cutter rigid outer frame a distance substantially equal to the distance between said cutter elements.

11. The sushi maker as claimed in claim 10, wherein before beginning said cutting off movement said cutter elements are positioned directly below and in line with an array of thin elements rigidly supported at the bottom of said container.

12. The sushi maker as claimed in claim 10, wherein said cutter elements comprise stainless steel wires.

13. The sushi maker as claimed in claim 10, further provided with a mechanism for driving said container to effect cutting.

14. The sushi maker as claimed in claim 13, wherein said mechanism can be operated by hand by applying pressure in a substantially downward direction.

15. The sushi maker as claimed in any of the claims being manually operated.

16. The sushi maker as claimed in any of the claims being electrically operated.

17. The sushi maker as claimed in any of the claims being pneumatic operated.

18. The sushi maker as claimed in any of the claims being hydraulically operated.
